(19) United States
(12) Patent Application Publication
(10) Pub. No.: US 2022/0134704 A1
(43) Pub. Date: May 5, 2022

(54) Multi-Layered Interlaced Membrane and Methods for Fabrication Thereof

(71) Applicant: Nano and Advanced Materials Institute Limited, Hong Kong (HK)

(72) Inventors: Ho Wang TONG, Hong Kong (HK); Yu Hang LEUNG, Hong Kong (HK); Chi Hang YU, Hong Kong (HK); Wing Man CHAN, Hong Kong (HK)

(21) Appl. No.: 17/431,432

(22) PCT Filed: Jul. 16, 2020
(86) PCT No.: PCT/CN2020/102270

§ 371 Date: Aug. 17, 2021

Related U.S. Application Data
(60) Provisional application No. 62/878,738, filed on Jul. 25, 2019.

(51) Int. Cl. B32B 5/26; B32B 5/08; B32B 5/02; D04H 1/728; D04H 1/724

(52) U.S. Cl. CPC B32B 5/26; B32B 5/08; B32B 2307/732; D04H 1/728; D04H 1/724; B32B 5/022

(57) ABSTRACT

The present invention provides a multi-layered interlaced membrane comprising at least one substrate layer including a plurality of first polymer-based microfibers; at least one nanofibrous layer including a plurality of second polymer-based nanofibers where each of the nanofibers has one or more nano-branches; at least one interlaced layer including a plurality of third polymer-based submicron fibers where each of the submicron fibers has one or more nano-branches and a plurality of fourth polymer-based nanofibers where each of the nanofibers has one or more nano-branches, wherein the third polymer-based submicron fibers are interlaced with the fourth polymer-based nanofibers; at least one submicron fibrous layer including a plurality of fifth polymer-based submicron fibers where each of the submicron fibers has one or more nano-branches. The nanofibrous layer is positioned onto the substrate layer; the interlaced layer is positioned onto the nanofibrous layer; the submicron fibrous layer is positioned onto the interlaced layer.

### CROSS-REFERENCE TO RELATED APPLICATION

This application is a 371 application of International Patent Application No. PCT/CN2020/102270 filed Jul. 16, 2020 which claims priority from U.S. provisional patent application Ser. No. 62/878,738 filed on Jul. 25, 2019, and the disclosures of which are incorporated herein by reference in its entirety.

### FIELD OF THE INVENTION

The present invention provides a multi-layered interlaced membrane and a method of fabricating the same. In particular, the multi-layered interlaced membrane comprises a substrate layer, a nanofibrous layer, an interlaced layer, and a microfibrous layer.

### BACKGROUND

In the past decades, electrospinning technology for fabrication of polymer fibers with diameters ranging from nanometers to several micrometers has rapidly developed because of the unique physical, chemical and biological properties of polymer fibers. Furthermore, with the advantage of large surface area and small controllable pore sizes, the single- or multi-layered membrane composed of electrospun fibers have been widely used in drug delivery, medical device, filtration, and reinforcement in composite materials. However, with the increase in the number of layers or thickness of the membrane, the major limitation of the existing membrane made of electrospun fibers is the weak adhesion between different layers and prone to delaminate while reaching certain thickness.

In view of the disadvantages of the existing membrane made of electrospun fibers, there is a need to provide a membrane not only with strong adhesion between different layers but also with the physical and functional features of electrospun fibers.

### SUMMARY OF THE INVENTION

Accordingly, a first aspect of the present invention provides a multi-layered interlaced membrane comprising at least one substrate layer which includes a plurality of first polymer-based microfibers, at least one nanofibrous layer which includes a plurality of second polymer-based nanofibers where each of the nanofibers has one or more nano-branches, at least one interlaced layer which includes a plurality of third polymer-based submicron fibers where each of the submicron fibers has one or more nano-branches and a plurality of fourth polymer-based nanofibers where each of the nanofibers has one or more nano-branches, wherein the third polymer-based submicron fibers are interlaced with the fourth polymer-based nanofibers and at least one submicron fibrous layer which includes a plurality of fifth polymer-based submicron fibers where each of the submicron fibers has one or more nano-branches. Exemplarily, the nanofibrous layer is positioned adjacent to the substrate layer, the interlaced layer is positioned adjacent to the nanofibrous layer, and the submicron fibrous layer is positioned adjacent to the interlaced layer.

In one embodiment of the present invention, the first polymer-based microfibers comprises one or more polymers selected from polyester, nylon, polyethylene, polyurethane, cellulose, polybutylene, terephthalate, polycarbonate, polymethylpentene, polystyrene.

In another embodiment of the present invention, the second polymer-based nanofibers, the third polymer-based submicron fibers, the fourth polymer-based nanofibers and fifth polymer-based submicron fibers comprise one or more polymers selected from collagen, elastin, gelatin, fibrinogen, fibrin, alginate, cellulose, silk fibroin, chitosan and chitin, hyaluronic acid, dextran, wheat gluten, polyhydroxyalkanoates, laminin, nylon, polyacrylic acid (PA), polycarbonate (PC), polybutylene terephthalate (PBT), polyurethane (PU), polyethylene vinyl acetate (PEVA), polycaprolactone (PCL), polyglycolic acid (PGA), polylactic acid (PLA), poly(lactic-co-glycolic acid) (PLGA), polyacrylonitrile (PAN), polystyrene (PS), polyvinyl alcohol (PVA), cellulose acetate (CA), polyethylene oxide (PEO), polyvinylidene fluoride (PVDF).

In another embodiment of the present invention, the third polymer-based submicron fibers and the fourth polymer-based nanofibers are from the same polymer solution.

In another embodiment of the present invention, the first polymer-based microfibers has a diameter from approximately 10 to 30 μm; the second polymer-based nanofibers has a diameter from approximately 10 to 100 nm; the third polymer-based submicron fibers has a diameter from approximately 100 to 1000 nm; the fourth polymer-based nanofibers has a diameter approximately from 10 to 100 nm; the fifth polymer-based submicron fibers has a diameter from approximately 100 to 1000 nm.

In another embodiment of the present invention, the substrate layer has a thickness from approximately 50 to 150 μm; the nanofibrous layer has a thickness from approximately 5 to 15 μm; the interlaced layer has a thickness from approximately 5 to 15 μm; the submicron fibrous layer has a thickness from approximately 5 to 15 μm.

In another embodiment of the present invention, it is provided that an article comprises the multi-layered interlaced membrane of the present invention. Such an article may have a filtering function for particulates as small as 40 nm with a filtration efficiency of at least 96.3% of the total particulates.

In another aspect, the present invention provides a method of fabricating a multi-layered interlaced membrane, which includes (1) Providing a first polymer solution comprising one or more polymers in a concentration from approximately 1 to 20% wt.; (2) Electrospinning the first polymer solution to form a nanofibrous layer comprising nanofibers having a diameter from approximately 10 to 100 nm, and each of the nanofibers has nano-branches with a diameter from approximately 10 to 100 nm, and the nanofibrous layer is electrospun onto the substrate layer; (3) Providing a second polymer solution comprising one or more polymers in a concentration from approximately 1 to 20% wt; (4) Electrospinning the second polymer solution to form an interlaced layer comprising submicron fibers having a diameter from approximately 100 to 1000 nm and nanofibers having a diameter from approximately 10 to 100 nm, and each of the nanofibers has nano-branches with a diameter from approximately 10 to 100 nm, and the interlaced layer is electrospun onto the nanofibrous layer; (5) Providing a third polymer solution comprising one or more polymers in a concentration from approximately 1 to 20% wt; and (6) Electrospinning the third polymer solution to form a submicron fibrous layer comprising submicron fibers having a diameter from approximately 100 to 1000 nm, and each of the submicron fibers has nano-branches with a diameter from approximately 10 to 100 nm, and the submicron fibrous layer is electrospun onto the interlaced layer.

In another embodiment of the present invention, any one or all of the first polymer solution, the second polymer solution, and the third polymer solution include at least two solvents selected from dimethylformamide, cyclohexanone, limonene, and 1-butanol, and having a ratio from 1:9 to 9:1 between two of said solvents.

In another embodiment of the present invention, the surface tension of the solvent is approximately from 20 to 40 mN/m.

In yet another embodiment of the present invention, any of said electrospinning in the present method can be repeated to form more than one of the nanofibrous layer, interlaced layer and/or the submicron fibrous layer in order to form the multi-layered interlaced membrane.

In a preferred embodiment, the diameter of each of the nano-branches is approximately from 10 to 30 nm.

A multi-layered interlaced membrane as-fabricated by the method of the present invention is also provided.

### BRIEF DESCRIPTION OF THE DRAWINGS

Embodiments of the present invention are described in more detail hereinafter with reference to the drawings, in which:

FIG. 1 illustrates a multi-layered interlaced membrane including a substrate layer, nanofibrous layer, interlaced layer and submicron fibrous layer.

FIG. 2 illustrates the SEM image of the interlaced layer having a plurality of nanofibers with nano-branches being interlaced with a plurality of submicron fibers with the nano-branches according to one embodiment of the present invention.

FIG. 3 illustrates the SEM image of the interlaced layer having a plurality of nanofibers with nano-branches being interlaced with a plurality of submicron fibers with nano-branches according to another embodiment of the present invention.

FIG. 4 illustrates the SEM image of the interlaced layer having a plurality of nanofibers with nano-branches being interlaced with a plurality of submicron fibers with nano-branches according to another embodiment of the present invention.

FIG. 5 illustrates the SEM image of the interlaced layer having a plurality of nanofibers with nano-branches being interlaced with a plurality of submicron fibers with nano-branches according to another embodiment of the present invention.

FIG. 6 illustrates the SEM image of the interlaced layer having a plurality of nanofibers with nano-branches being interlaced with a plurality of submicron fibers with nano-branches according to another embodiment of the present invention.

### DEFINITIONS

References in the specification to “one embodiment”, “an embodiment”, “an example embodiment”, etc., indicate that the embodiment described can include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “a” or “an” are used to include one or more than one and the term “or” is used to refer to a nonexclusive “or” unless otherwise indicated. In addition, it is to be understood that the phraseology or terminology employed herein, and not otherwise defined, is for the purpose of description only and not of limitation. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference should be considered supplementary to that of this document; for irreconcilable inconsistencies, the usage in this document controls.

In the methods of preparation described herein, the steps can be carried out in any order without departing from the principles of the invention, except when a temporal or operational sequence is explicitly recited. Recitation in a claim to the effect that first a step is performed, and then several other steps are subsequently performed, shall be taken to mean that the first step is performed before any of the other steps, but the other steps can be performed in any suitable sequence, unless a sequence is further recited within the other steps. For example, claim elements that recite “Step A, Step B, Step C, Step D, and Step E” shall be construed to mean step A is carried out first, step E is carried out last, and steps B, C, and D can be carried out in any sequence between steps A and E, and that the sequence still falls within the literal scope of the claimed process. A given step or sub-set of steps can also be repeated. Furthermore, specified steps can be carried out concurrently unless explicit claim language recites that they be carried out separately. For example, a claimed step of doing X and a claimed step of doing Y can be conducted simultaneously within a single operation, and the resulting process will fall within the literal scope of the claimed process.

### DETAILED DESCRIPTION

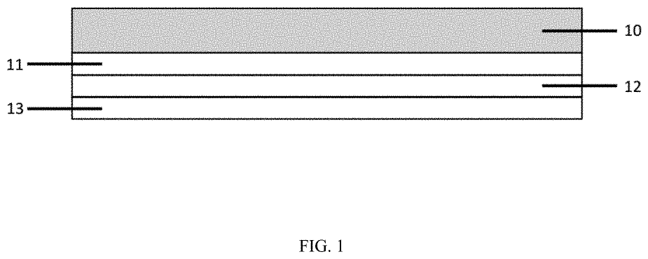

The present invention provides a multi-layered interlaced membrane having at least one substrate layer 10, at least one nanofibrous layer 11, at least one interlaced layer 12 and at least one submicron fibrous layer 13 as shown in FIG. 1. The substrate layer with a thickness approximately 50 to 150 μm is a nonwoven having a plurality of hydrophobic microfibers which are produced by spunbonding. The diameter of microfibers is approximately 10 to 30 μm. This layer serves as a substrate for coating the nanofibrous layer, interlaced layer and microfibrous layer.

The nanofibrous layer is positioned adjacent to the substrate layer. The nanofibrous layer with a thickness approximately 5 to 15 μm is a nonwoven comprising a plurality of nanofibers which are produced by free surface electrospinning. The diameter of nanofibers is approximately 10 to 100 nm. There are multiple nano-branches with the length approximately from 100 to 300 nm being found along the surface of the nanofibers, and the diameter of nano-branches is approximately 10 to 100 nm.

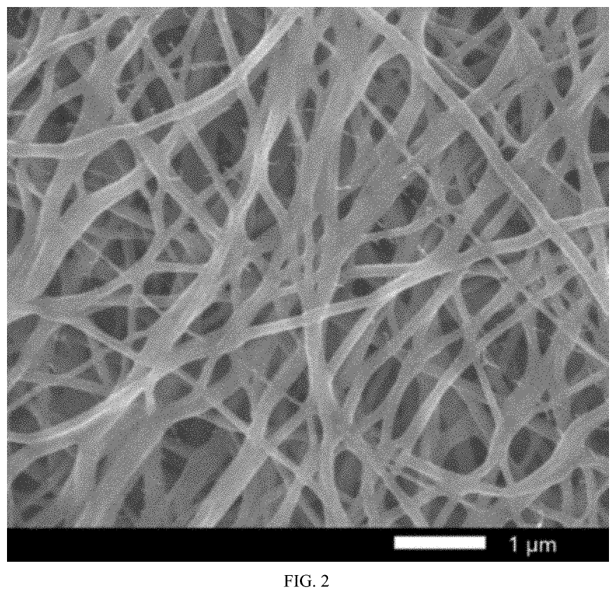

The interlaced layer is positioned adjacent to the nanofibrous layer. The interlaced layer with a thickness approximately 5 to 15 μm is a nonwoven comprising a plurality of submicron fibers interlaced with a plurality of nanofibers which are produced by free surface electrospinning. The diameter of submicron fibers is approximately 100 to 1000 nm, and the diameter of nanofibers is approximately 10 to 100 nm. There are multiple nano-branches with the length approximately from 100 to 300 nm being found along the surface of the nanofibers, and the diameter of nano-branches is approximately 10 to 100 nm (FIG. 2).

The submicron fibrous layer is positioned adjacent to the interlaced layer. The submicron fibrous layer with a thickness approximately 5 to 15 μm is a nonwoven comprising a plurality of submicron fibers which are produced by free surface electrospinning. The diameter of submicron fibers is approximately 100 to 1000 nm. There are multiple nano-branches with the length approximately from 100 to 300 nm being found along the surface of the nanofibers, and the diameter of nano-branches is approximately 10 to 100 nm

In nanofibrous layer, interlaced layer, and submicron fibrous layer, the formation of multiple nano-branches on the surface of the electrospun fibers would increase the friction between the fibers, thus preventing delamination of different layers when the thickness of the fibrous layer is high.

Furthermore, the multi-layered interlaced membrane is capable of being a filtration barrier to filter out contaminants of different sizes ranging from 30 nm to 10 μm. The presence of the nanofibers is for filtering out small sized contaminants; the presence of the interlaced structure is for filtering out medium sized contaminants; and the presence of the submicron fibers is for filtering out relatively large sized contaminants. The contaminants can be non-oil based, oil-based, or both. The contaminants can be in solid form such as soot, particulates in diesel exhaust, asphalt fume and oil mist. The contaminants can be viruses such as influenza, varicella zoster virus, variola and measles. The contaminants can be bacteria such as Mycobacterium tuberculosis and Bacillus anthracis. The contaminants can be fungi such as Cryptococcus neoformans. The contaminants in a form of particulates may have an average size of at least approximately 40 nm such that the present interlaced membrane being a filtration barrier can reach a filtration efficiency of at least 96.3% of the total particulates.

In another aspect of the present invention, it provides a method of fabricating a multi-layered interlaced membrane which includes (1) Providing a first polymer solution having one or more polymers in a concentration from approximately 1 to 20% wt; (2) Electrospinning the first polymer solution to form a nanofibrous layer comprising a plurality of nanofibers having a diameter from approximately 10 to 100 nm with nano-branches having a diameter from approximately 10 to 100 nm where the nanofibrous layer is positioned onto the substrate layer; (3) Providing a second polymer solution having one or more polymers in a concentration from approximately 1 to 20% wt; (4) Electrospinning the second polymer solution to form an interlaced layer comprising a plurality of submicron fibers having a diameter from approximately 100 to 1000 nm and a plurality of nanofibers having a diameter from approximately 10 to 100 nm with nano-branches having a diameter from approximately 10 to 100 nm where the interlaced layer is positioned onto the nanofibrous layer; (5) Providing a third polymer solution having one or more polymers in a concentration from approximately 1 to 20% wt; (6) Electrospinning the third polymer solution to form a submicron fibrous layer comprising a plurality of submicron fibers having a diameter from approximately 100 to 1000 nm with nano-branches having a diameter from approximately 10 to 100 nm where the submicron fibrous layer is positioned onto the interlaced layer.

The first, second and third polymer solutions described hereinabove include the use of mixture of at least two different solvents with the surface tension approximately from 20 to 40 mN/m to dissolve the polymer such that the polymer solution possesses the surface tension within a range that allows electrostatic force to overcome it throughout the polymer jet during the electrospinning process, thus forming multiple Taylor cones on the polymer jet and hence multiple nano-branches on the electrospun fibers. The at least two different solvents are selected from dimethylformamide, cyclohexanone, limonene, and 1-butanol with a ratio from 1:9 to 9:1. Furthermore, in order to perform in a needleless electrospinning system with an upward spinning direction, the solvents as-selected also require at least the following three features: (1) A boiling point in the range of 80° C. to 200° C.; (2) A saturation vapor pressure of 0.2-50 kPa (0.0035-0.1 bar, atmosphere) at 20° C.; (3) A flash point of at least 10° C. higher than the room temperature.

Table 1 lists the major components of the polymer solution described herein along with their corresponding weight percentage and exemplary materials for each of the components

| Component | Percentage | Exemplary Materials |
|---|---|---|
| Polymers | 1%-20% | collagen, elastin, gelatin, fibrinogen, |
| | | fibrin, alginate, cellulose, |
| | | silk fibroin, chitosan and chitin, |
| | | hyaluronic acid, dextran, wheat |
| | | gluten, polyhydroxyalkanoates, |
| | | laminin, nylon, polyacrylic acid |
| | | (PA), polycarbonate (PC), polybutylene |
| | | terephthalate (PBT), |
| | | polyurethane (PU), polyethylene |
| | | vinyl acetate (PEVA), |
| | | polycaprolactone (PCL), polyglycolic |
| | | acid (PGA), polylactic |
| | | acid (PLA), poly(lactic-co- |
| | | glycolic acid) (PLGA), |
| | | polyacrylonitrile (PAN), |
| | | polystyrene (PS), polyvinyl alcohol |
| | | (PVA), cellulose acetate (CA), |
| | | polyethylene oxide (PEO), |
| | | polyvinylidene fluoride (PVDF). |
| Solvent | 10%-90% | dimethylformamide, cyclohexanone, |
| | | limonene, and 1-butanol |

### Example 1

Synthesis of the Multi-Layered Interlaced Structure

17% of polystyrene (PS) and 0.1% of tetramethylammonium bromide (TEAB) was dissolved in a mixture of dimethylformamide (DMF) and limonene (LMN) (DMF:LMN=1:1.6) to obtain the first polymer solution. The first polymer solution was loaded into a needleless electrospinning with upward spinning direction where electrospinning of the first polymer solution was performed under the following conditions to form the nanofibrous layer 11: Electrode distance: 180 mm; Voltage: 50 kV; Metal insert size: 0.6 mm; Carriage speed: 350 mm/s; Air condition in spinning chamber: 30% RH and 22° C. Then, 12% of PS and 0.15% of TEAB was dissolved in a mixture of DMF and LMN (DMF:LMN=1:1.3) to obtain the second polymer solution. The second polymer solution was loaded into a needleless electrospinning with upward spinning direction where electrospinning of the second polymer solution was performed under the following conditions to form the interlaced layer 12: Electrode distance: 180 mm; Voltage: 55 kV; Metal insert size: 0.6 mm; Carriage speed: 350 mm/s; Air condition in spinning chamber: 30% RH and 22° C. And 8% of PS and 0.18% of TEAB was dissolved in a mixture of DMF and LMN (DMF:LMN=1:1.1) to obtain the third polymer solution. The third polymer solution was loaded into a needleless electrospinning with upward spinning direction where electrospinning of the third polymer solution was performed under the following conditions to form the submicron fibrous layer 13: Electrode distance: 180 mm; Voltage: 60 kV; Metal insert size: 0.6 mm; Carriage speed: 350 mm/s; Air condition in spinning chamber: 30% RH and 22° C.

Fiber Morphology of the Nanofibrous Layer

The diameter of the nanofibers of the nanofibrous layer electrospun from the first polymer solution prepared according to EXAMPLE 1 is in a range of 40-50 nm.

The thickness of the nanofibrous layer electrospun from the same first polymer solution is about 6 μm.

The diameter of the nano-branches on the nanofibers is in a range of 10-30 nm and the length of the nano-branches on the nanofibers is in a range of 100-300 nm.

Fiber Morphology of the Interlaced Layer

The diameter of the submicron fibers of the interlaced layer electrospun from the second polymer solution prepared according to EXAMPLE 1 is in a range of 110-130 nm.

The diameter of the nanofibers of the interlaced layer electrospun from the same second polymer solution is in a range of 60-70 nm.

The thickness of the interlaced layer is about 9 μm.

The diameter of the nano-branches on the nanofibers is in a range of 10-30 nm and the length of the nano-branches on the nanofibers is in a range of 100-300 nm.

The diameter of the nano-branches on the submicron fibers is in a range of 10-30 nm and the length of the nano-branches on the submicron fibers is in a range of 100-300 nm.

Fiber Morphology of the Submicron Fibrous Layer

The diameter of the submicron fibers of the submicron fibrous layer electrospun from the third polymer solution prepared according to EXAMPLE 1 is in a range of 400-450 nm.

The thickness of the submicron fibrous layer is about 12 μm.

The diameter of the nano-branches on the submicron fibers is in a range of 10-30 nm and the length of the nano-branches on the submicron fibers is in a range of 100-300 nm.

Performance of the Multi-Layered Interlaced Membrane

Table 2 shows the filtration efficiency of the multi-layered interlaced membrane as-fabricated according to the preceding EXAMPLES for both non-oil based particulates [sodium chloride (NaCl)] and oil based particulates [dispersed oil particulates (DOP)] with different sizes at a face velocity of 5.9 cm/s was determined, respectively. For example, the filtration efficiency for 40 nm NaCl was 97.5%.

TABLE 2
The filtration efficiency of different sizes of NaCl and DOP
in multi-layered interlaced membrane

| | Size | | | | |
|---|---|---|---|---|---|
| Particulate | 40 nm | 100 nm | 180 nm | 330 nm | 880 nm |
| NaCl | 97.5% | 98.2% | 98.8% | 99.2% | 99.8% |
| DOP | 96.3% | 97.3% | 97.9% | 98.6% | 99.1% |

(The filtration efficiency was shown in “%”)

### Example 2

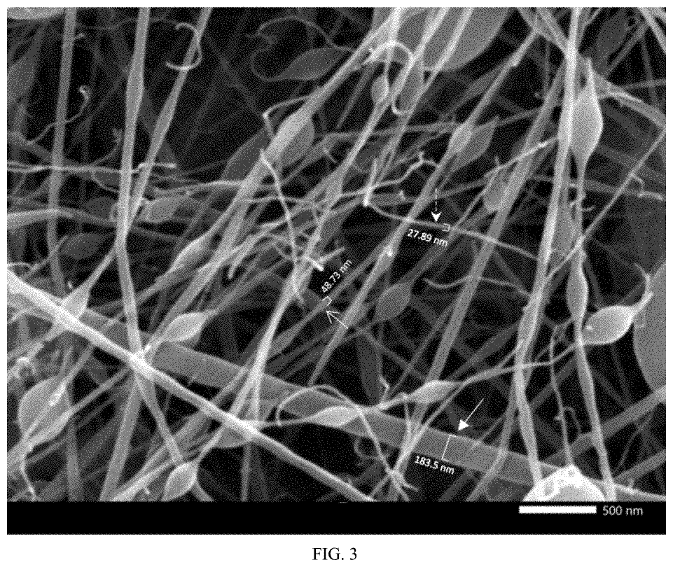

According to some embodiments of the present invention, 8% Polyacrylonitrile (PAN), 0.1% Benzyltriethylammonium chloride (BTEAC) was dissolved in DMF to obtain the second polymer solution. The second polymer solution was electrospinned with upward spinning direction to form the interlaced layer. The diameter of submicron fibers of the interlaced layer is in a range of 180-190 nm (FIG. 3, arrow); the diameter of nanofibers of the interlaced layer is in a range of 20-80 nm (FIG. 3, open arrow); the diameter of nano-branches of the interlaced layer is in a range of 10-30 nm (FIG. 3, dashed arrow). In addition, the surface tension of the interlaced layer is approximately 35.2 mN/m.

### Example 3

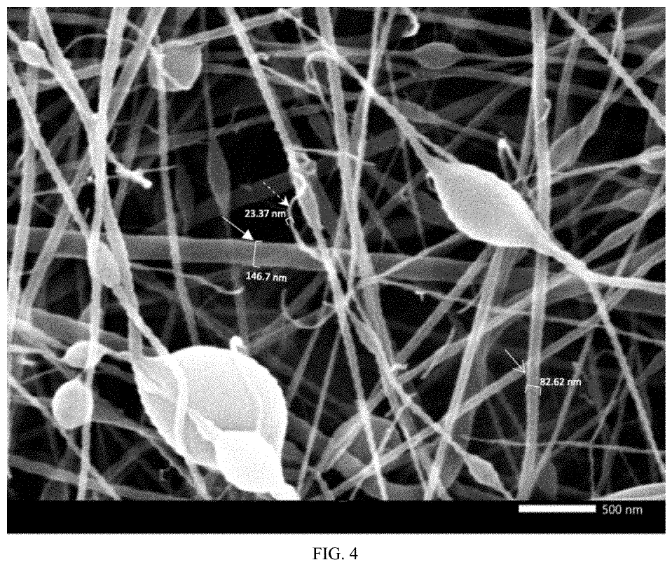

According to some embodiments of the present invention, 8% Polyacrylonitrile (PAN), 0.1% Benzyltriethylammonium chloride (BTEAC), 1% L-Ascorbic acid was dissolved in DMF to obtain the second polymer solution. The second polymer solution was electrospinned with upward spinning direction to form the interlaced layer. The diameter of submicron fibers of the interlaced layer is in a range of 140-150 nm (FIG. 4, arrow); the diameter of nanofibers of the interlaced layer is in a range of 20-90 nm (FIG. 4, open arrow); the diameter of nano-branches of the interlaced layer is in a range of 10-30 nm (FIG. 4, dashed arrow). In addition, the surface tension of the interlaced layer is approximately 35.2 mN/m.

### Example 4

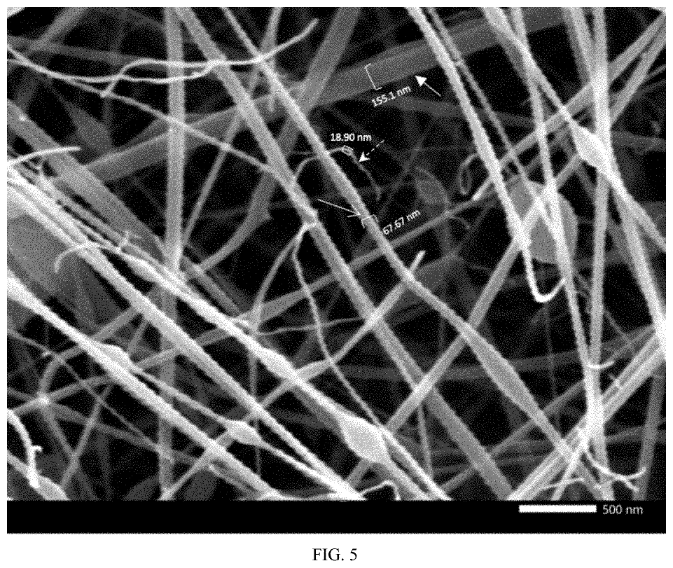

According to some embodiments of the present invention, 8% Polyacrylonitrile (PAN), 0.1% Benzyltriethylammonium chloride (BTEAC), 1% Green tea extract was dissolved in DMF to obtain the second polymer solution. The second polymer solution was electrospinned with upward spinning direction to form the interlaced layer. The diameter of submicron fibers of the interlaced layer is in a range of 150-160 nm (FIG. 5, arrow); the diameter of nanofibers of the interlaced layer is in a range of 10-70 nm (FIG. 5, open arrow); the diameter of nano-branches of the interlaced layer is in a range of 10-30 nm (FIG. 5, dashed arrow). In addition, the surface tension of the interlaced layer is approximately 35.2 mN/m.

### Example 5

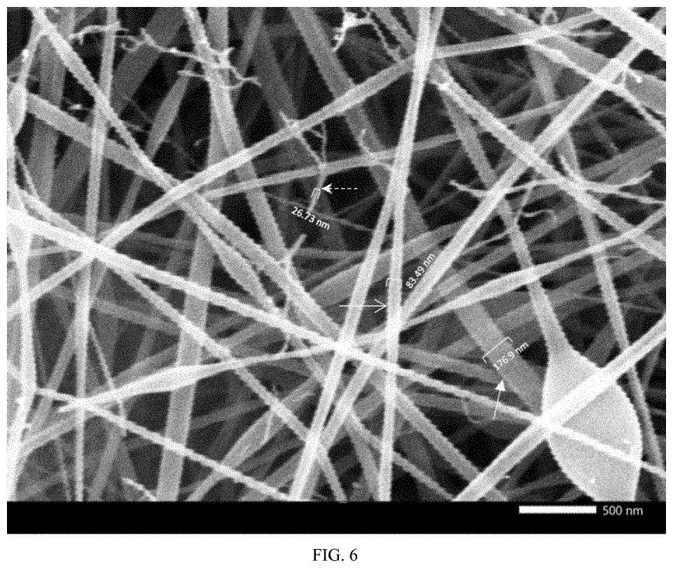

According to some embodiments of the present invention, 8% Polyacrylonitrile (PAN), 0.1% Benzyltriethylammonium chloride (BTEAC), 3% Green tea extract was dissolved in DMF to obtain the second polymer solution. The second polymer solution was electrospinned with upward spinning direction to form the interlaced layer. The diameter of submicron fibers of the interlaced layer is in a range of 140-180 nm (FIG. 6, arrow); the diameter of nanofibers of the interlaced layer is in a range of 10-90 nm (FIG. 6, open arrow), the diameter of nano-branches of the interlaced layer is in a range of 10-30 nm (FIG. 6, dashed arrow). In addition, the surface tension of the interlaced layer is approximately 35.2 mN/m.

1. A multi-layered interlaced membrane comprising:
at least one substrate layer comprising a plurality of first polymer-based microfibers;
at least one nanofibrous layer including a plurality of second polymer-based nanofibers where each of the nanofibers has one or more nano-branches;
at least one interlaced layer comprising a plurality of third polymer-based submicron fibers where each of the submicron fibers has one or more nano-branches and a plurality of fourth polymer-based nanofibers where each of the nanofibers has one or more nano-branches; and
at least one submicron fibrous layer comprising a plurality of fifth polymer-based submicron fibers where each of the submicron fibers has one or more nano-branches;
wherein the nanofibrous layer is positioned adjacent to at least one substrate layer; the interlaced layer is positioned adjacent to at least one nanofibrous layer; the third polymer-based submicron fibers are interlaced with the fourth polymer-based nanofibers; the submicron fibrous layer positioned adjacent to at least one interlaced layer, and
wherein each of the nano-branches has a diameter from approximately 10 nm to approximately 100 nm and a length from approximately 100 nm to approximately 300 nm.

2. The multi-layered interlaced membrane of claim 1, wherein the first polymer-based microfibers are produced by spunbonding.

3. The multi-layered interlaced membrane of claim 1, wherein the second polymer-based nanofibers, the third polymer-based submicron fibers, the fourth polymer-based nanofibers and the fifth polymer-based submicron fibers are produced by free surface electrospinning.

4. The multi-layered interlaced membrane of claim 1, wherein the first polymer-based microfibers comprises one or more polymers selected from polyester, nylon, polyethylene, polyurethane, cellulose, polybutylene, terephthalate, polycarbonate, polymethylpentene, polystyrene.

5. The multi-layered interlaced membrane of claim 1, wherein the second polymer-based nanofibers comprises one or more polymers selected from collagen, elastin, gelatin, fibrinogen, fibrin, alginate, cellulose, silk fibroin, chitosan and chitin, hyaluronic acid, dextran, wheat gluten, polyhydroxyalkanoates, laminin, nylon, polyacrylic acid (PA), polycarbonate (PC), polybutylene terephthalate (PBT), polyurethane (PU), polyethylene vinyl acetate (PEVA), polycaprolactone (PCL), polyglycolic acid (PGA), polylactic acid (PLA), poly(lactic-co-glycolic acid) (PLGA), polyacrylonitrile (PAN), polystyrene (PS), polyvinyl alcohol (PVA), cellulose acetate (CA), polyethylene oxide (PEO), and/or polyvinylidene fluoride (PVDF).

6. The multi-layered interlaced membrane of claim 1, wherein the third polymer-based submicron fibers comprises one or more polymers selected from collagen, elastin, gelatin, fibrinogen, fibrin, alginate, cellulose, silk fibroin, chitosan and chitin, hyaluronic acid, dextran, wheat gluten, polyhydroxyalkanoates, laminin, nylon, polyacrylic acid (PA), polycarbonate (PC), polybutylene terephthalate (PBT), polyurethane (PU), polyethylene vinyl acetate (PEVA), polycaprolactone (PCL), polyglycolic acid (PGA), polylactic acid (PLA), poly(lactic-co-glycolic acid) (PLGA), polyacrylonitrile (PAN), polystyrene (PS), polyvinyl alcohol (PVA), cellulose acetate (CA), polyethylene oxide (PEO), and/or polyvinylidene fluoride (PVDF).

7. The multi-layered interlaced membrane of claim 1, wherein the fourth polymer-based nanofibers comprises one or more polymers selected from collagen, elastin, gelatin, fibrinogen, fibrin, alginate, cellulose, silk fibroin, chitosan and chitin, hyaluronic acid, dextran, wheat gluten, polyhydroxyalkanoates, laminin, nylon, polyacrylic acid (PA), polycarbonate (PC), polybutylene terephthalate (PBT), polyurethane (PU), polyethylene vinyl acetate (PEVA), polycaprolactone (PCL), polyglycolic acid (PGA), polylactic acid (PLA), poly(lactic-co-glycolic acid) (PLGA), polyacrylonitrile (PAN), polystyrene (PS), polyvinyl alcohol (PVA), cellulose acetate (CA), polyethylene oxide (PEO), and/or polyvinylidene fluoride (PVDF).

8. The multi-layered interlaced membrane of claim 1, wherein the fifth polymer-based submicron fibers comprises one or more polymers selected from collagen, elastin, gelatin, fibrinogen, fibrin, alginate, cellulose, silk fibroin, chitosan and chitin, hyaluronic acid, dextran, wheat gluten, polyhydroxyalkanoates, laminin, nylon, polyacrylic acid (PA), polycarbonate (PC), polybutylene terephthalate (PBT), polyurethane (PU), polyethylene vinyl acetate (PEVA), polycaprolactone (PCL), polyglycolic acid (PGA), polylactic acid (PLA), poly(lactic-co-glycolic acid) (PLGA), polyacrylonitrile (PAN), polystyrene (PS), polyvinyl alcohol (PVA), cellulose acetate (CA), polyethylene oxide (PEO), and/or polyvinylidene fluoride (PVDF).

9. The multi-layered interlaced membrane of claim 1, wherein the third polymer-based submicron fibers and the fourth polymer-based nanofibers are selected from the same polymer.

10. The multi-layered interlaced membrane of claim 1, wherein the first polymer-based microfibers has a diameter from approximately 10 to approximately 30 μm.

11. The multi-layered interlaced membrane of claim 1, wherein the second polymer-based nanofibers has a diameter from approximately 10 to approximately 100 nm.

12. The multi-layered interlaced membrane of claim 1, wherein the third polymer-based submicron fibers has a diameter from approximately 100 to approximately 1000 nm.

13. The multi-layered interlaced membrane of claim 1, wherein the fourth polymer-based nanofibers has a diameter from approximately 10 to approximately 100 nm.

14. The multi-layered interlaced membrane of claim 1, wherein the fifth polymer-based submicron fibers has a diameter from approximately 100 to approximately 1000 nm.

15. The multi-layered interlaced membrane of claim 1, wherein the substrate layer has a thickness from approximately 50 to approximately 150 μm.

16. The multi-layered interlaced membrane of claim 1, wherein the nanofibrous layer has a thickness approximately 5 to 15 μm; the interlaced layer has a thickness approximately 5 to approximately 15 μm.

17. The multi-layered interlaced membrane of claim 1, wherein the submicron fibrous layer has a thickness approximately 5 to 15 μm.

18. The multi-layered interlaced membrane of claim 1, wherein the diameter of each of the nano-branches is from approximately 10 nm to approximately 30 nm.

19. A method of fabricating a multi-layered interlaced membrane, comprising:
providing a first polymer solution having one or more polymers in a concentration from approximately 1 to approximately 20% wt.;
electrospinning the first polymer solution to form a nanofibrous layer onto the substrate layer, said nanofibrous layer comprising a plurality of nanofibers having a diameter from approximately 10 to approximately 100 nm, and each of said nanofibers comprising a plurality of nano-branches having a diameter from approximately 10 to approximately 100 nm;
providing a second polymer solution having one or more polymers in a concentration from approximately 1 to approximately 20% wt.;
electrospinning the second polymer solution to form an interlaced layer onto the nanofibrous layer, said interlaced layer comprising a plurality of submicron fibers having a diameter from approximately 100 to approximately 1000 nm and a plurality of nanofibers having a diameter from approximately 10 to approximately 100 nm, and each of said nanofibers comprising nano-branches having a diameter from approximately 10 to approximately 30 nm, and each of said submicron fibers comprising nano-branches having a diameter from approximately 10 to approximately 100 nm;
providing a third polymer solution having one or more polymers in a concentration from approximately 1 to approximately 20% wt.;
electrospinning the third polymer solution to form a submicron fibrous layer onto the interlaced layer, said submicron fibrous layer comprising a plurality of submicron fibers having a diameter from approximately 100 to approximately 1000 nm, and each of said submicron fibers comprising nano-branches having a diameter from approximately 10 to approximately 30 nm;
wherein the one or more polymers in each of the first, second and third polymer solutions is/are selected from collagen, elastin, gelatin, fibrinogen, fibrin, alginate, cellulose, silk fibroin, chitosan and chitin, hyaluronic acid, dextran, wheat gluten, polyhydroxyalkanoates, laminin, nylon, polyacrylic acid (PA), polycarbonate (PC), polybutylene terephthalate (PBT), polyurethane (PU), polyethylene vinyl acetate (PEVA), polycaprolactone (PCL), polyglycolic acid (PGA), polylactic acid (PLA), poly(lactic-co-glycolic acid) (PLGA), polyacrylonitrile (PAN), polystyrene (PS), polyvinyl alcohol (PVA), cellulose acetate (CA), polyethylene oxide (PEO), and/or polyvinylidene fluoride (PVDF).

20. The method of claim 19, wherein the substrate layer has a thickness from approximately 50 to approximately 150 μm.

21. The method of claim 19, wherein the nanofibrous layer has a thickness from approximately 5 to 15 μm.

22. The method of claim 19, wherein the interlaced layer has a thickness from approximately 5 to 15 μm.

23. The method of claim 19, wherein the submicron fibrous layer has a thickness from approximately 5 to 15 μm.

24. The method of claim 19, wherein one or more of the first, second, third polymer solutions further comprises at least two solvents selected from dimethylformamide, cyclohexanone, limonene, and 1-butanol.

25. The method of claim 24, wherein the first, second, and/or third polymer solution has two solvents in a volume ratio from 1:9 to 9:1.

26. The method of claim 24, wherein the surface tension of the at least two solvents is approximately from 20 to 40 mN/m.

27. The method of claim 19, wherein the diameter of each of the nano-branches is from approximately 10 nm to approximately 30 nm.

28. An article comprising the multi-layered interlaced membrane of claim 1.

29. A multi-layered interlaced membrane fabricated by the method of claim 19.
